(19) United States
(12) Patent Application Publication
(10) Pub. No.: US 2026/0070657 A1
(43) Pub. Date: Mar. 12, 2026

(54) LUGGAGE COMPARTMENT FOR AN AIRCRAFT

(71) Applicant: FACC AG, Ried im Innkreis (AT)

(72) Inventors: Bernhard KAMMERER, Zell an der Pram (AT); Matúš DOCOLOMANSKÝ, Svaty Jur (SK)

(21) Appl. No.: 19/108,377

(22) PCT Filed: Sep. 6, 2023
(86) PCT No.: PCT/AT2023/060310

§ 371 Date: Mar. 3, 2025

(30) Foreign Application Priority Data
Sep. 6, 2022 (AT) A 50675/2022

(51) Int. Cl. B64D 11/00; E05F 3/00

(52) U.S. Cl. CPC B64D 11/003; E05F 3/00; E05Y 2201/422; E05Y 2201/474; E05Y 2900/502

(57) ABSTRACT

A luggage compartment for an aircraft, comprising: a luggage compartment housing, a bucket for accommodating a piece of luggage, a hinge between the luggage compartment housing and the bucket, wherein the bucket can be lowered from a closed position to an open position by pivoting about the hinge, a device for self-opening of the bucket both in an unloaded state and in a state loaded with the piece of luggage, wherein the device for self-opening of the bucket comprises a spring device having a spring element that pushes the bucket in the direction of the open position.

### CROSS REFERENCE TO RELATED APPLICATIONS

The present application is a U.S. National Phase of International Application No. PCT/AT2023/060310 entitled “LUGGAGE COMPARTMENT FOR AN AIRCRAFT,” and filed on Sep. 6, 2023. International Application No. PCT/AT2023/060310 claims priority to Austrian Patent Application No. A 50675/2022 filed on Sep. 6, 2022. The entire contents of each of the above-listed applications are hereby incorporated by reference for all purposes.

### TECHNICAL FIELD

The invention relates to a luggage compartment for an aircraft, comprising:
a luggage compartment housing,
a bucket for accommodating a piece of luggage,
a hinge between the luggage compartment housing and the bucket,
whereby the bucket can be lowered from a closed position to an open position by pivoting about the hinge.

### BACKGROUND AND SUMMARY

As described in WO2014/117198, overhead luggage compartments for aircraft are known in various embodiments. In one embodiment, a fixed housing is provided, which is closed by a flap that can be pivoted upward. This type of luggage compartment is also referred to as a “shelf bin.” In such luggage compartments, it has long been known to install springs to facilitate the upward pivoting of the flap (cf. e.g. DE 10 2016 006 004 A1). When the flap is closed, the springs are tensioned.

Another embodiment of overhead luggage compartments, by contrast, provides a lowerable bucket into which carry-on luggage can be placed. These luggage compartments are referred to as “pivot bins” (cf. e.g. DE 10 2013 003 364 A1). After releasing a latching device, often referred to as a “latch,” the bucket lowers to the open position under its own weight. To require as little force as possible from the user to close the bucket, the pivot axis between the bucket and the housing is arranged horizontally near the common center of gravity of the bucket and the piece of luggage. For typical loadings, this ensures that the bucket is self-opening even when loaded, i.e., it moves to the open position solely by gravity and without additional force applied by the user. In practice, however, it has turned out to be problematic that, in certain loading situations, the bucket can lose its self-opening property, causing the bucket to remain in a partially open state when opened. In addition, this also results in the bucket, which has been manually lowered to the open position, being partly self-closing, i.e. pivoting on its own—without the user intervening—into a partially open state.

By contrast, the object of the present invention is to alleviate or even eliminate the disadvantages of the known “pivot bins.” The invention preferably aims to create a luggage compartment with a lowerable bucket that is self-opening regardless of the loading condition.

This object is achieved with a luggage compartment according to Claim 1 and with an aircraft according to Claim 8. Preferred embodiments are specified in the dependent claims.

According to the invention, a device for self-opening of the bucket is provided both in an unloaded state and in a state loaded with the piece of luggage, the device for self-opening of the bucket comprising a spring device with a spring element that pushes the bucket toward the open position.

The invention is first based on the realization that the bucket's self-opening is not ensured if a small, heavy piece of luggage is placed in the rear area of the bucket, i.e. on the side facing away from the loading opening with respect to the hinge. In this loading situation, the common center of gravity of the bucket and the piece of luggage can, in the horizontal direction, shift behind the pivot axis. This exerts a closing torque on the bucket, which prevents self-opening of the bucket, so that the bucket does not move from the closed to the open position solely by gravity. If the user pulls the bucket into the open position, this closing torque can cause partial self-closing of the bucket, i.e., the bucket pivots on its own, without user intervention, into a partially open state. Aware of this cause of the problem, the invention provides the device for self-opening the bucket—i.e., transferring the bucket from the closed to the open position solely by gravity—not only in an unloaded state but also in a state loaded with the piece of luggage. The device for self-opening of the bucket is equipped with a spring device whose spring element—in contrast to conventional luggage compartments that provide support when lifting—pushes the bucket in the direction of the lowered open position. The spring element exerts an opening torque, i.e., a torque acting in the direction of the open position, on the bucket, which ensures self-opening of the bucket regardless of the loading condition, in particular also when a piece of luggage is placed in the rear area of the bucket (i.e. chute).

For the purposes of this disclosure, location and directional indications such as “horizontal,” “vertical,” “above,” “below” refer to the intended mounting state of the luggage compartment in an aircraft cabin with the aircraft oriented horizontally. “Front” refers to the side of the luggage compartment facing the user; “rear” refers to the side of the luggage compartment facing away from the user.

The bucket comprises a receiving space for the piece of luggage. For this purpose, as is customary in the prior art, the bucket can comprise a preferably longitudinally extended floor in the aircraft fuselage's longitudinal direction for placing the piece of luggage and two side walls at the longitudinal ends of the floor. The side walls are arranged transverse to the longitudinal direction of the floor and extend upward from the floor. In addition, the bucket can comprise an enclosure with an upper wall section and a rear wall section, optionally also with a lower wall section separate from the floor. A loading opening is formed at the front side of the bucket to allow placement of the piece of luggage in the receiving space when loading in the open position of the bucket. The bucket is connected via the hinge to the luggage compartment housing, which is fixed, i.e., immovable during the opening of the bucket, in the aircraft cabin.

As is also common in the prior art, the luggage compartment housing can comprise two side parts that may extend essentially parallel to the side walls of the bucket. In addition, the luggage compartment housing can comprise an upper part, a front part, and a rear part. In the closed position, the front part can cover the loading opening of the bucket. The rear part is provided on the side of the luggage compartment facing away from the loading opening.

Preferably, there is each one hinge provided between one of the bucket's side walls and one of the housing's side parts. The hinges define a pivot axis, which preferably runs in the aircraft fuselage's longitudinal direction, about which the bucket is pivoted from the closed position into the fully lowered open position. In the open position, a front loading opening, i.e., the side facing the user, is freed, which extends above a loading edge. In the closed position, the front loading opening of the luggage compartment is closed.

Preferably, the luggage compartment comprises a latching device between the bucket and the luggage compartment housing. In the latched state of the latching device, the bucket is held in the closed position. In the unlatched state of the latching device, pivoting of the bucket from the closed position to the open position is enabled. An actuating device, in particular a handle, can be provided for transferring the latching device from the latched to the unlatched state.

As a spring element of the device for self-opening, a compression spring is preferably provided, which is more strongly tensioned in the closed position of the bucket than in the open position of the bucket. When the luggage compartment is opened, the compression spring is relaxed, releasing the spring energy stored during the preceding closing of the luggage compartment. Advantageously, even if a piece of luggage is accommodated in the rear area of the bucket, i.e., in the area behind the hinge, the relaxation of the compression spring reliably opens the bucket. A helical spring is preferably provided as the compression spring.

To prevent undesired deformation of the spring element transverse to its longitudinal direction, the spring device in a preferred embodiment comprises a support element that passes through the spring element from one longitudinal end to the other. In this embodiment, the spring element is arranged on the outside of the support element. This can ensure that the spring element is only tensioned and relaxed in its longitudinal direction. Buckling or kinking with respect to the longitudinal direction of the spring element is reliably prevented.

In a preferred embodiment, the support element comprises a cylinder and a piston, with the piston extending to different lengths out of the cylinder depending on the tension of the spring element. The cylinder-piston support element increases the longitudinal stiffness of the spring device. To allow the length to be adjusted to the tension, in particular the compression of the spring element, the piston can extend out of the interior of the cylinder to a corresponding length. Preferably, however, the cylinder-piston support element is not designed as a damping element, in particular without fluid being displaced by movement of the piston inside the cylinder.

To create suitable connection points for the spring device on both sides of the spring element, it is advantageous if the support element comprises two pistons, each of which is extended out of the cylinder in opposite directions depending on the tension of the spring element. The free end of one piston can be connected to the luggage compartment housing, and the free end of the other piston can be connected to the bucket.

To prevent abrupt opening of the luggage compartment, particularly when loaded, a preferred embodiment provides a damping device between the luggage compartment housing and the bucket, which damps the pivoting of the bucket from the closed position to the open position. The damping device comprises a damping element, in particular a cylinder-piston unit in which a fluid volume is displaced by the movement of the piston.

In a preferred embodiment, a first bracket on the luggage compartment housing and a second bracket on the bucket are provided, wherein first longitudinal ends of each of the spring device and the damping device are mounted on the first bracket, and second longitudinal ends of each of the spring device and the damping device are mounted on the second bracket, preferably in a pivotable manner.

The invention will be further explained below with reference to an exemplary embodiment shown in the drawings.

### BRIEF DESCRIPTION OF THE FIGURES

FIG. 1 shows an overhead luggage compartment according to the invention with a bucket in the closed position.

FIG. 2 shows the overhead luggage compartment of FIG. 1 in the open position.

FIGS. 3 and 4 show partially cut-away sectional views of the overhead luggage compartment in the closed position according to FIG. 1 and in the open position according to FIG. 2, respectively.

FIG. 5 shows a spring and damping device in a tensioned state of the spring device corresponding to the closed position of the overhead luggage compartment of FIGS. 1 and 2.

FIG. 6 shows the spring and damping device of FIG. 3 in the relaxed state of the spring device corresponding to the open position of the overhead luggage compartment of FIGS. 1 and 2.

### DETAILED DESCRIPTION

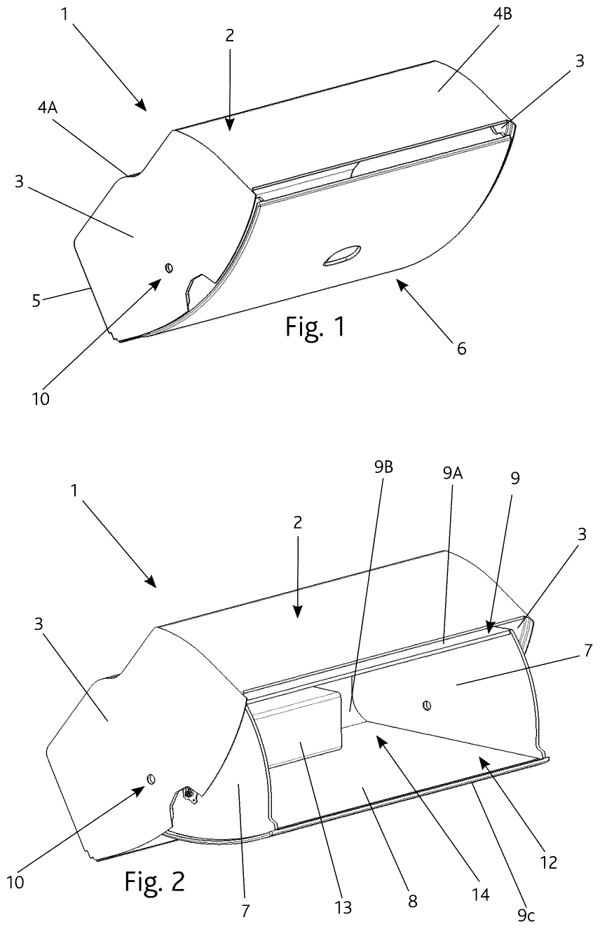

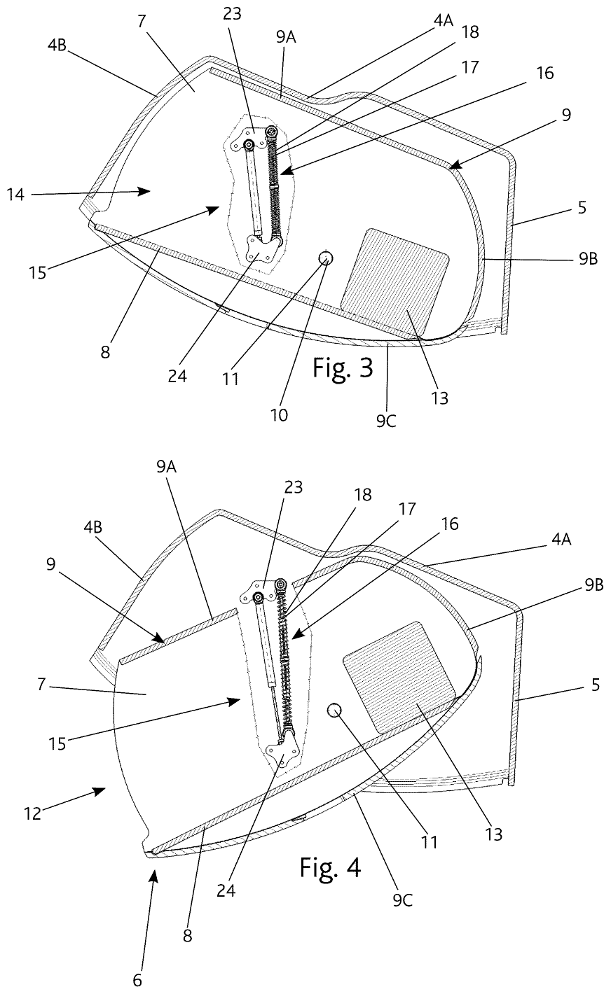

The drawings show an overhead luggage compartment 1, which is installed in an aircraft cabin of an (not illustrated) aircraft. The overhead luggage compartment 1 comprises a downward-open luggage compartment housing 2 with two opposite side parts 3, an upper part 4A, a front part 4B, and a rear part 5. The luggage compartment housing 2 is stationary arranged, i.e. immovable when the luggage compartment 1 is opened, on the aircraft fuselage. A forward-open bucket 6 is pivotably arranged on the luggage compartment housing 2. The bucket 6 comprises two side walls 7, a floor 8, and an enclosure 9 with an upper wall section 9A, a rear wall section 9B, and a lower wall section 9C, on which the floor 8 is arranged. To mount the bucket 6 pivotably, hinges 10 are provided between the bucket's side walls 7 and the side parts 3 of the luggage compartment housing 2. The hinges 10 define a horizontal pivot axis 11, about which the bucket 6 can be lowered from a closed position shown in FIG. 1 and FIG. 3 to an open position shown in FIG. 2 and FIG. 4. In the open position, a front loading opening 12 is freed so that a piece of luggage 13 can be inserted into a receiving space 14 of the bucket 6 bounded by the side walls 7, the floor 8, the upper wall section 9A, and the rear wall section 9B. In the closed position, the front loading opening 12 of the luggage compartment 1 is closed, with the loading opening 12 covered by the front part 4B of the housing 2.

The luggage compartment 1 comprises a latching device (not shown) acting between the bucket 6 and the luggage compartment housing 2. In the latched state of the latching device, the bucket 6 is held in the closed position. In the unlatched state of the latching device, the bucket 6 is freed for pivoting from the closed position to the open position, preferably by more than 30°, in particular by more than 40°, about the pivot axis 11, which remains stationary during this time. An actuating device, in particular a handle, can be provided to transfer the latching device from the latched to the unlatched state.

If a small, heavy piece of luggage 13 (cf. FIG. 3 and FIG. 4) is placed in the rear area of the receiving space 14 of the bucket 6, the common center of gravity of the bucket 6 and the piece of luggage 13 could shift behind the pivot axis 11. This would create a closing torque causing self-closing of the luggage compartment 1 in the open state or preventing self-opening of the luggage compartment 1 in the closed but unlatched state.

To avoid this problem, in the embodiment shown, the luggage compartment 1 comprises a device 15 for self-opening of the bucket 6 not only in an unloaded state, i.e. with the receiving space 14 empty, but also in a loaded state. The device 15 for self-opening of the bucket 6 in the unlatched state of the latching device comprises a spring device 16 with a spring element 17 that pushes the bucket 6 into the fully open position. With the help of the spring element 17, an opening torque is generated such that the bucket 6 is also self-opening—i.e. opening without user force—if the piece of luggage 13 is located behind the pivot axis 11. For this purpose, the spring element 17 acts on the front portion of the bucket 6, which extends from the hinge 10 up to the front loading edge facing the user. Preferably, a device 15 of this type is provided at each of the opposite longitudinal ends of the luggage compartment 1, and the following explanations apply equally to both devices 15.

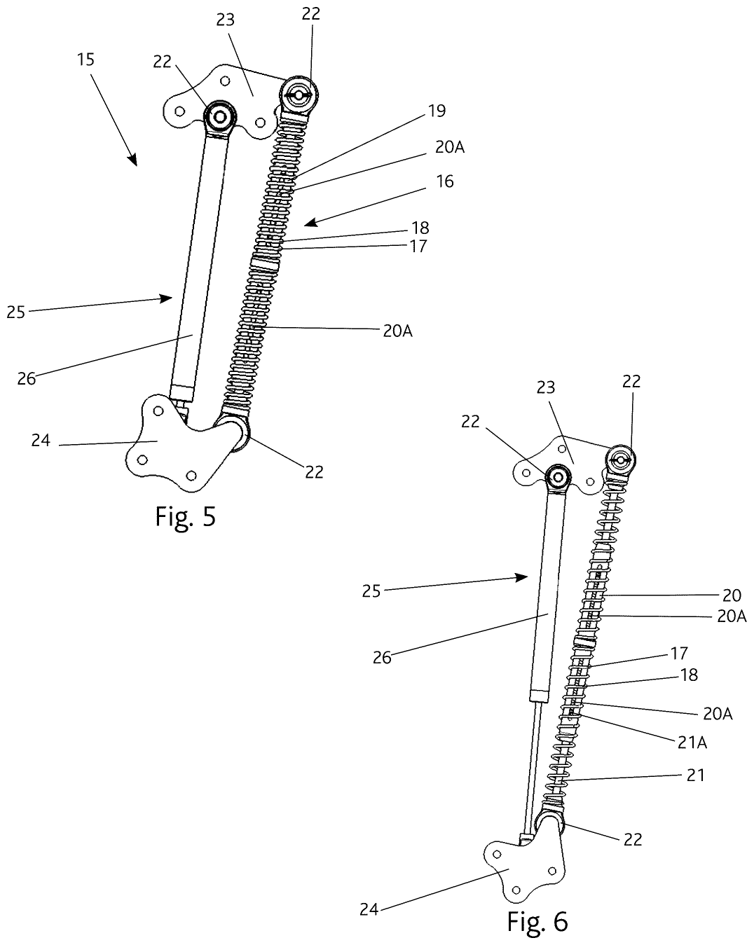

As shown in FIG. 5 and FIG. 6, a compression spring 18, in this case in the form of a helical spring, is provided as the spring element 17 in the embodiment shown, which is more strongly tensioned in the closed position of the bucket 6 than in the open position of the bucket 6. When the bucket 6 is opened, the compression spring 18 is relaxed so that an opening torque (in addition to the resultant moment due to gravity) is applied to the bucket 6.

As further evident from FIG. 5 and FIG. 6, in the embodiment shown the spring device 16 also comprises a support element 19 that passes through the spring element 17 in its longitudinal direction, i.e. from one longitudinal end of the spring element 17 to the other. The support element 19 comprises a cylinder 20 and two pistons 21, each of which extends out of the cylinder 20 in opposite directions by a distance depending on the tension of the spring element 17. The cylinder 20 has elongated holes 20A in which stop parts 21A connected to the pistons 21 are guided to limit the movement of the pistons 21 relative to the cylinder 20 under the action of the spring element 17.

At the free ends of the pistons 21, connecting elements 22 projecting from the spring element 17 are provided, which are pivotably connected to a first bracket 23 on the luggage compartment housing 2 or respectively on a second bracket 24, on the bucket 6.

As further evident from FIG. 5 and FIG. 6, a damping device 25 is also provided between the side part 3 of the luggage compartment housing and the side wall 7 of the bucket 6. By means of the damping device 25, the pivoting of the bucket from the closed to the open position is damped, but no spring force, and thus no additional static opening or closing torque, is applied to the bucket 6. The damping device 25 comprises a cylinder-piston damper 26. One longitudinal end of the cylinder-piston damper 26 is pivotably connected to the first bracket 23, and the other longitudinal end of the cylinder-piston damper is pivotably connected to the second bracket 24.

### LIST OF REFERENCE SIGNS

1 Luggage compartment
2 Luggage compartment housing
3 Side parts of the luggage compartment housing
4A Upper part of the luggage compartment housing
4B Front part of the luggage compartment housing
5 Rear part of the luggage compartment housing
6 Bucket
7 Side walls of the bucket
8 Floor of the bucket
9 Enclosure of the bucket
9A Upper wall section of the enclosure
9B Rear wall section of the enclosure
9C Lower wall section of the enclosure
10 Hinges
11 Pivot axis
12 Loading opening
13 Piece of luggage
14 Receiving space
15 Device
16 Spring device
17 Spring element
18 Compression spring
19 Support element
20 Cylinder
20A Elongated holes 20A
21 Pistons
21A Stop parts
22 Connecting elements
23 First bracket
24 Second bracket
25 Damping device
26 Cylinder-piston damper

1. A luggage compartment for an aircraft, comprising:
a luggage compartment housing,
a bucket for accommodating a piece of luggage,
a hinge between the luggage compartment housing and the bucket, wherein the bucket can be lowered from a closed position to an open position by pivoting about the hinge, and
a device for self-opening of the bucket both in an unloaded state and in a state loaded with the piece of luggage,
wherein the device for self-opening of the bucket comprises a spring device having a spring element that pushes the bucket toward the open position.

2. The luggage compartment according to claim 1, wherein a compression spring is provided as the spring element, which is more strongly tensioned in the closed position of the bucket than in the open position of the bucket.

3. The luggage compartment according to claim 1, wherein the spring device comprises a support element that passes through the spring element from one longitudinal end of the spring element to the other.

4. The luggage compartment according to claim 3, wherein the support element comprises a cylinder and a piston, wherein the piston is extended to different lengths out of the cylinder depending on the tension of the spring element.

5. The luggage compartment according to claim 4, wherein the support element comprises two pistons, each of which is extended out of the cylinder in opposite directions depending on the tension of the spring element.

6. The luggage compartment according to claim 1, wherein a damping device is provided between the luggage compartment housing and the bucket, which damps the pivoting of the bucket from the closed position to the open position.

7. The luggage compartment according to claim 6, wherein a first bracket is provided on the luggage compartment housing and a second bracket is provided on the bucket, wherein first longitudinal ends of each of the spring device and the damping device are mounted on the first bracket, and second longitudinal ends of each of the spring device and the damping device are mounted on the second bracket.

8. An aircraft having a luggage compartment according to claim 1.
